(19) United States
(12) Patent Application Publication
(10) Pub. No.: US 2026/0302597 A1
(43) Pub. Date: Oct. 1, 2026

(54) BROADBEAM LENS-INTEGRATED MMWAVE HARVESTER FOR SMART CITY ENVIRONMENTS

(71) Applicant: GEORGIA TECH RESEARCH CORPORATION, Atlanta, GA (US)

(72) Inventors: Marvin JOSHI, Atlanta, GA (US); Kexin HU, Atlanta, GA (US); Charles A. LYNCH, Atlanta, GA (US); Emmanouil M. TENTZERIS, Atlanta, GA (US)

(21) Appl. No.: 19/633,031

(22) Filed: Mar. 30, 2026

Related U.S. Application Data
(60) Provisional application No. 63/779,852, filed on Mar. 28, 2025.

(51) Int. Cl. H01Q 1/24; H01Q 9/04; H01Q 15/08; H02J 50/00; H02J 50/27

(52) U.S. Cl. CPC H01Q 1/248; H01Q 9/0414; H01Q 9/0428; H01Q 15/08; H02J 50/001; H02J 50/27

(57) ABSTRACT

An exemplary device and method are disclosed for a scalable, broadband, dielectric lens-based mmWave energy harvester with wide total solid angular coverage and mW-level that employs a pixel array of rectennas, each incorporating a circularly polarized aperture-coupled stacked patch antenna and a broadband, high-sensitivity rectifier, enhanced by a biconvex dielectric lens to achieve a wide solid angle coverage. With its broadbeam coverage and high efficiency, the exemplary device and method can be employed to lower-power sensors and remote devices without reliance on conventional power infrastructure.

### RELATED APPLICATION

This application claims priority to, and the benefit of, U.S. Provisional Patent Application No. 63/779,852, filed Mar. 28, 2025, entitled “BROADBEAM EQUICONVEX LENS-INTEGRATED MMWAVE HARVESTER FOR SMART CITY ENVIRONMENTS,” which is incorporated by reference herein in its entirety.

### GOVERNMENT SPONSORSHIP CLAUSE

This invention was made with government support under 2322366, awarded by the National Science Foundation. The government has certain rights in the invention.

### BACKGROUND

Smart cities rely on networks of low-power Internet of Things (IoT) devices for environmental monitoring, traffic management, public safety sensing, and other functions. More than 80 billion IoT devices may interact with urban infrastructure in the future, creating substantial demand for sustainable, maintenance-free power sources.

There is a benefit to improving the power-harvesting system and method for networks of IoT devices in smart cities.

### SUMMARY

An exemplary device and method are disclosed for a scalable, broadband, dielectric lens-based mmWave energy harvester with wide total solid angular coverage and mW-level that employs a pixel array of rectennas, each incorporating a circularly polarized aperture-coupled stacked patch antenna and a broadband, high-sensitivity rectifier, enhanced by a biconvex dielectric lens to achieve a wide solid angle coverage. With its broadbeam coverage and high efficiency, the exemplary device and method can be employed to lower-power sensors (e.g., IoT) and remote devices without reliance on conventional power infrastructure.

The exemplary device and method is configured to harvest energy from background electromagnetic signals (e.g., millimeter-wave (mmWave) signals) and generating electrical power (e.g., direct current (DC) power) from the harvested energy. In some implementations, the exemplary device and method include (i) a biconvex dielectric lens (e.g., ±550 angular coverage) configured to capture electromagnetic signals, (ii) an array of circularly polarized multilayer antennas configured to improve the gain and bandwidth of the captured signals and harvest their electromagnetic energy, and (iii) an array of half-wave rectifiers configured to convert the harvested energy into DC power for powering electronic devices (e.g., IoT devices).

Unlike energy harvesters that rely on lower-frequency radio-frequency (RF) signals with limited power and operational range, the exemplary device and method use 5G/mmWave transmissions to enable higher-power delivery and more effective harvesting over substantially longer distances. The combination of a biconvex dielectric lens and a multilayer circularly polarized rectenna array can provide angular coverage and harvested power that are not achievable with current energy harvesters. The use of circular polarization can further facilitate orientation-agnostic operation, allowing reliable energy capture regardless of placement or rotational alignment of the exemplary device and method. Additionally, the RF-to-DC conversion, in the exemplary device and method, across a wide solid angle can improve performance in dense, dynamic urban environments, providing a more sustainable, lower-maintenance power solution than battery-based systems or lower-efficiency RF harvesters.

The exemplary device and method can also support various commercial applications. In smart cities, the exemplary device and method can facilitate large-scale, self-sustaining operation of IoT devices, reducing battery replacement requirements and minimizing long-term maintenance costs. The long-range energy-harvesting capability (e.g., providing mW-level power at distances up to 80 m) makes the exemplary device and method suitable for remote, industrial, or otherwise hard-to-access installations. The exemplary device and method can also benefit 5G and telecommunications infrastructures, where mmWave beams can be used for data transmission and as a supplemental power source to reduce network-related power demands. With the combination of broad angular coverage, efficient power conversion, and compatibility with current 5G/mmWave deployments, the exemplary device and method can provide a scalable, environmentally sustainable power solution for future high-density sensing and communication networks.

In an aspect, a device is disclosed comprising: an antenna circuit assembly; a domed lens optically coupled to the antenna circuit assembly, the domed lens being configured to direct one or more electromagnetic signals to one or more locations on the antenna circuit assembly in a radial pattern; and a rectifier circuit assembly (e.g., summation network) operatively coupled to the antenna circuit assembly, the rectifier circuit assembly being configured to rectify electromagnetic energy harvested from the antenna circuit assembly (e.g., into electrical power).

In some embodiments, the antenna circuit assembly includes a set of antennas, each being located at a respective location of the one or more locations, and wherein the antenna circuit assembly is configured to: harvest, via the set of antennas, the electromagnetic energy from the one or more electromagnetic signals at the one or more locations.

In some embodiments, each antenna in the set of antennas includes at least one substrate, including a first substrate (e.g., parasitic patch) and a second substrate (e.g., radiating patch), wherein the first substrate is stacked on the second substrate, wherein the first substrate is configured to improve gain or bandwidth of the one or more electromagnetic signals, and wherein the second substrate is configured to harvest the electromagnetic energy from the improved one or more electromagnetic signals for delivery to the rectifier circuit assembly.

In some embodiments, the rectifier circuit assembly includes a set of rectifiers, each being located in correspondence with a respective antenna in the set of antennas, and wherein the rectifier circuit assembly is configured to: generate, via the set of rectifiers, an electrical power (e.g., DC power) using the harvested electromagnetic energy, wherein the generated electrical power is subsequently used for powering electronic devices.

In some embodiments, the domed lens is a biconvex dielectric lens comprises: a first optical assembly comprising: a first curved surface forming a central region of the first optical assembly, and a first flat surface extending from the first curved surface, wherein the first flat surface forms a surrounding region of the central region of the first optical assembly; and a second optical assembly comprising: a second curved surface forming a central region of the second optical assembly, and a second flat surface extending from the second curved surface, wherein the second flat surface forms a surrounding region of the central region of the second optical assembly, wherein the first flat surface is fixably coupled to the second flat surface such that (i) the first curved surface is disposed opposite the second curved surface and (ii) the central region of the first optical assembly is disposed opposite the central region of the second optical assembly.

In some embodiments, antennas in the one set of antennas form the radial pattern including one antenna located at a center of the radial pattern and subsequent antennas located concentrically around the center of the radial pattern.

In some embodiments, the at least one substrate of each antenna in the set of antennas (e.g., of the antenna circuit assembly) is stacked on a substrate for a respective rectifier in the set of rectifiers (e.g., of the rectifier circuit assembly).

In some embodiments, the antenna circuit assembly is configured to receive the directed one or more electromagnetic signals across a frequency band of 25.5 to 30.5 GHz.

In some embodiments, each antenna in the set of antennas is a circularly polarized antenna configured with an axial ratio below 3 dB across a frequency band of 25.5 to 30.5 GHz.

In some embodiments, the domed lens provides an angular coverage of at least 550 for each of the one or more electromagnetic signals.

In some embodiments, the device described herein further comprises: an actuator operatively coupled to the domed lens, wherein the actuator is configured to actuate the domed lens across angles of 0° to 360°.

In some embodiments, the rectifier circuit assembly further comprises: one or more filters (e.g., bypass diodes) configured to exclude electrical power generated by rectifiers using electromagnetic energy below a predefined energy value.

In some embodiments, the device described herein further comprises: a second antenna circuit assembly; a second domed lens optically coupled to the second antenna circuit assembly, the second domed lens being configured to direct the one or more electromagnetic signals to second one or more locations on the second antenna circuit assembly in a second radial pattern; and a second rectifier circuit assembly (e.g., summation network) operatively coupled to the second antenna circuit assembly, the second rectifier circuit assembly being configured to rectify second electromagnetic energy harvested from the second antenna circuit assembly (e.g., into electrical power).

In some embodiments, the second antenna circuit assembly includes a second set of antennas, each being located at a respective location of the second one or more locations, and wherein the second antenna circuit assembly is configured to: harvest, via the second set of antennas, the second electromagnetic energy from the one or more electromagnetic signals at the second one or more locations.

In some embodiments, each antenna in the second set of antennas includes at least one substrate, including a third substrate (e.g., parasitic patch) and a fourth substrate (e.g., radiating patch), wherein the third substrate is stacked on the fourth substrate, wherein the third substrate is configured to improve gain or bandwidth of the one or more electromagnetic signals, and wherein the fourth substrate is configured to harvest the second electromagnetic energy from the improved one or more electromagnetic signals for delivery to the second rectifier circuit assembly.

In some embodiments, the second rectifier circuit assembly includes a second set of rectifiers, each being located in correspondence with a respective antenna in the second set of antennas, and wherein the second rectifier circuit assembly is configured to: generate, via the second set of rectifiers, a second electrical power (e.g., DC power) using the harvested second electromagnetic energy, wherein the generated second electrical power is subsequently used for powering electronic devices.

In some embodiments, the generated electrical power and the generated second electrical power are combined to be used for powering the electronic devices.

In another aspect, a device is disclosed comprising: at least two antenna circuit assemblies, including a first circuit assembly and a second circuit assembly; at least two domed lenses, including a first domed lens optically coupled to the first antenna circuit assembly and a second domed lens optically coupled to the second antenna circuit assembly, wherein the first domed lens is operatively coupled to the second domed lens, wherein the first domed lens is configured to direct one or more electromagnetic signals to first one or more locations on the first antenna circuit assembly in a first radial pattern, and wherein the second domed lens is configured to direct the one or more electromagnetic signals to second one or more locations on the second antenna circuit assembly in a second radial pattern; and at least two rectifier circuit assemblies, including a first rectifier circuit assembly operatively coupled to the first antenna circuit assembly and a second rectifier circuit assembly operatively coupled to the second antenna circuit assembly, wherein the first rectifier circuit assembly is configured to rectify first electromagnetic energy harvested from the first antenna circuit assembly (e.g., into electrical power), and wherein the second rectifier circuit assembly is configured to rectify second electromagnetic energy harvested from the second antenna circuit assembly.

In some embodiments, the at least two antenna circuit assemblies form a first substrate of the device, wherein the at least two rectifier circuit assemblies form a second substrate of the device, and wherein the first substrate is stacked on the second substrate.

In yet another aspect, a method is disclosed comprising: providing an antenna circuit assembly; directing, via a domed lens, one or more electromagnetic signals to one or more locations on an antenna circuit assembly in a radial pattern; and rectifying, via a rectifier circuit assembly, electromagnetic energy harvested from the antenna circuit assembly into electrical power.

### BRIEF DESCRIPTION OF DRAWINGS

FIGS. 1A, 1B, 1C, 1D, 1E, 1F, and 1G each show an example device for generating electrical power from electromagnetic signals, in accordance with an illustrative embodiment.

FIG. 2A shows an example domed lens in the exemplary device, in accordance with an illustrative embodiment.

FIG. 2B shows an example dome assembly comprising a plurality of domed lenses in the exemplary device, in accordance with an illustrative embodiment.

FIG. 2C shows an example supporting structure configured to hold the exemplary device, in accordance with an illustrative embodiment.

FIG. 3 shows an example method of generating electrical power using harvested electromagnetic energy, in accordance with an illustrative embodiment.

FIG. 4A shows an experimental energy-harvesting device and its implementation in a smart city.

FIG. 4B shows a stackup diagram of a circularly polarized aperture-coupled stacked patch antenna, along with its measured and simulated S₁₁ and axial ratio results.

FIG. 4C shows a broadband millimeter-wave (mmWave) rectifier in the experimental device, measured and simulated Siu results of the rectifier, and measured and simulated power conversion efficiency of the rectifier.

FIG. 4D shows standard deviations of a ray bundle from a back surface of a biconvex dielectric lens at angles of incidence, simulated peak realized gain and 3 dB angular coverage of the lens, simulated peak realized gain at boresight and 3 dB angular coverage, stackup diagram of the experimental device with the lens, top and bottom layers of the device, and a DC combiner network for the device.

FIG. 4E shows simulated and measured antenna gain of the experimental device across angles of incidence, simulated and measured axial ratios across angles of incidence, power impinging onto the device, and harvested power from the device.

FIG. 4F shows an evaluation of a single-unit-cell configuration of the experimental device, along with simulated and measured harvested and incident power density across angles of incidence.

FIG. 4G shows an evaluation of a scaled 2×2 configuration of the experimental device, along with simulated and measured harvested power across angles of incidence.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example Device

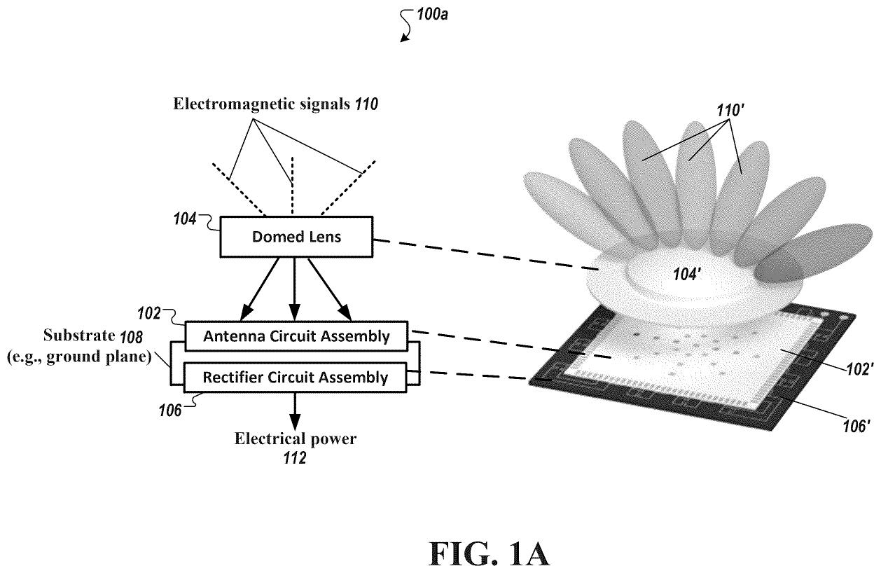

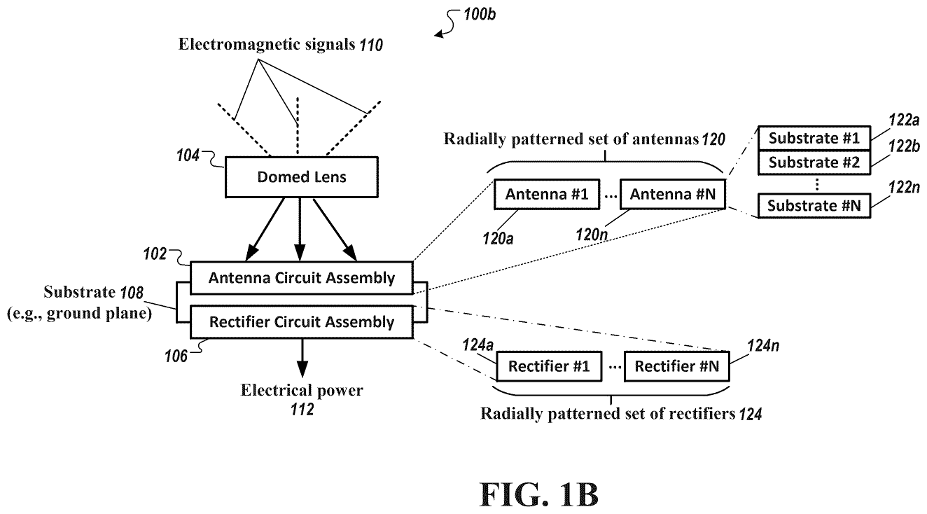

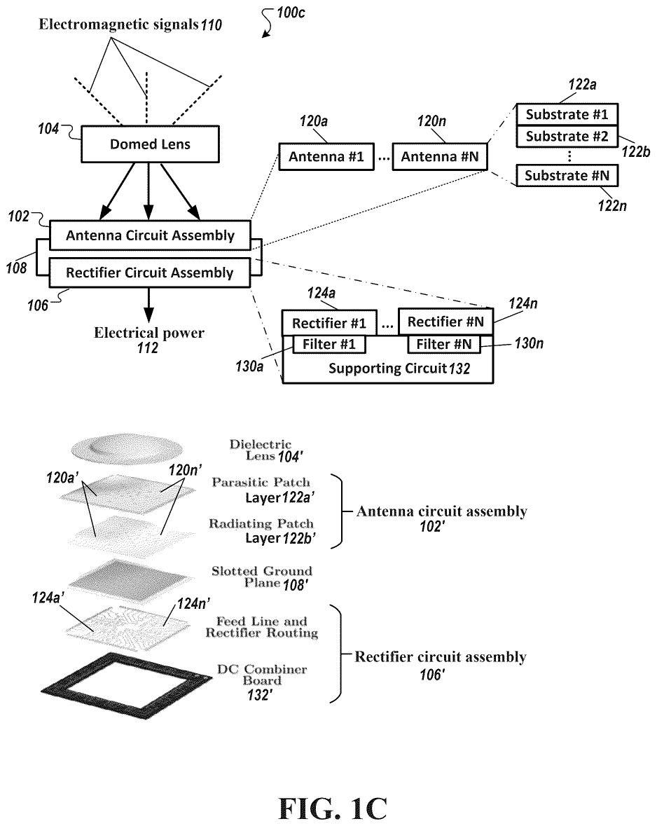

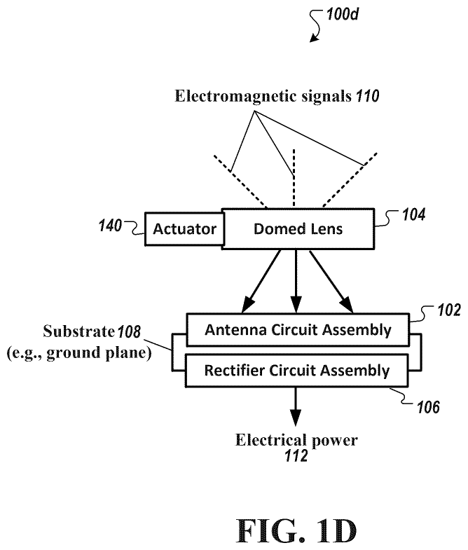

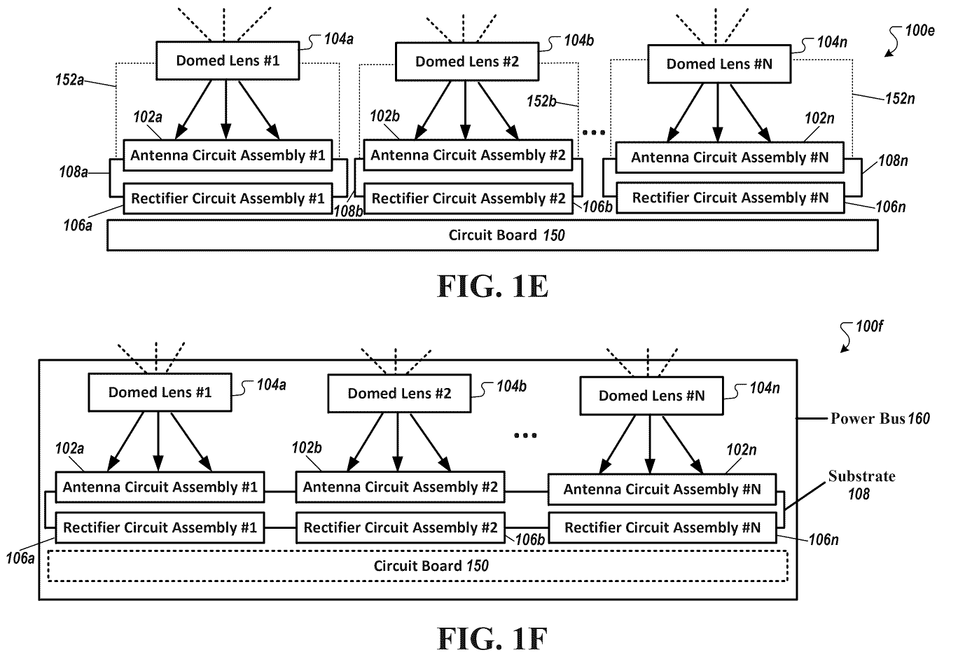

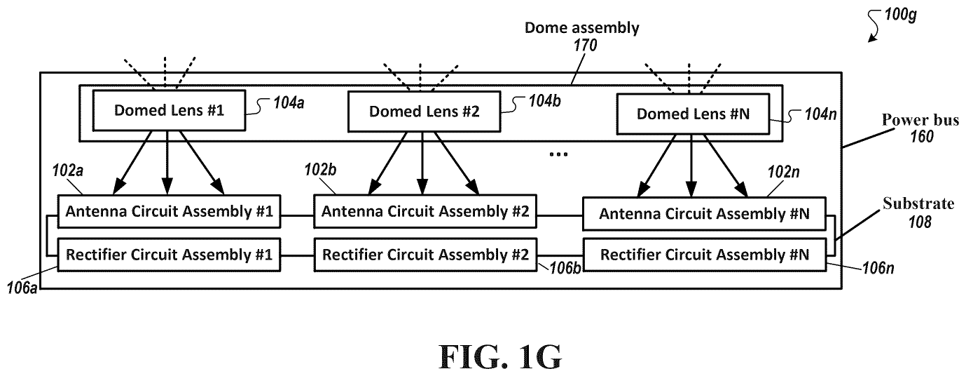

FIGS. 1A, 1B, 1C, 1D, 1E, 1F, and 1G each show an example dielectric lens-based mmWave energy harvester device 100 (shown as 100a, 100b, 100c, 100d, 100e, 100f, and 100g) with wide total solid angular coverage for generating electrical power 112 (e.g., direct current (DC) power) from one or more electromagnetic signals 110 (e.g., millimeter wave (mmWave)), in accordance with an illustrative embodiment.

In FIGS. 1A-1C, the exemplary device 100 (e.g., 100a-100c) includes at least an antenna circuit assembly 102, a domed lens 104, and a rectifier circuit assembly 106. The antenna circuit assembly 102 and rectifier circuit assembly 106 are fabricated on one or more substrates 108 that is mechanically coupled directly to the domed lens 104 or to a housing structure that maintains the optical paths between them. In FIG. 1D, the exemplary device 100 (e.g., 100d) further includes an actuator 140 configured to rotate the domed lens 104 over an angle range of 0° to 360°.

Antenna Circuit Assembly (102). In the example shown in FIGS. 1A-1D, the antenna circuit assembly 102 (shown as 102′) is optically coupled (e.g., via a supporting structure) to the domed lens 104 (shown as 104′). The antenna circuit assembly 102 is also operatively coupled, via a substrate 108 (shown as 108′) (e.g., ground plane), to the rectifier circuit assembly 106. In some embodiments, the antenna circuit assembly 102 and associated set of antennas 120 are stacked on a substrate for the rectifier circuit assembly 106 and associated set of rectifiers 124 (e.g., with the substrate 108 in the middle of the stack).

The antenna circuit assembly 102 is configured to receive the electromagnetic signals 110 that are directed in a radial pattern to one or more locations (referred to as signal-receiving locations) thereon by the domed lens 104. In some embodiments, the antenna circuit assembly 102 is configured to receive the signals 110 across a frequency band of 25.5 to 30.5 GHz.

To receive the signals 110, the antenna circuit assembly includes the radially patterned set of antennas 120 (referred to as an antenna array), each antenna 120a-120n (shown as antenna #1-#N) located at a respective one of the locations to which the signals 110 are directed. The antenna circuit assembly 102 is then configured to harvest, via the set of antennas 120, electromagnetic energy from the signals 110 at the signal-receiving locations. In the radial pattern of the set of antennas 120, one antenna can be located at the center of the pattern, and subsequent antennas can be located concentrically around the center antenna.

Each antenna 120a-120n can be a multilayer antenna having at least one substrate/layer 122a-122n (shown as substrate #1-#N), including a first substrate 122a (shown as 122a′) (e.g., parasitic layer/patch) and a second substrate 122b (shown as 122b′) (e.g., radiating layer/patch), where the first substrate 122a is stacked on the second substrate 122b. In some embodiments, the first substrate 122a (e.g., parasitic patch) is configured to improve the gain or bandwidth of the electromagnetic signals 110, and the second substrate 122b (e.g., radiating patch) is configured to harvest the electromagnetic energy from the improved electromagnetic signals for delivery to the rectifier circuit assembly 106. In some embodiments, each antenna is a circularly polarized multilayer antenna with an axial ratio below 3 dB over the frequency band 25.5 to 30.5 GHz.

Rectifier Circuit Assembly (106). In FIGS. 1A-1D, the rectifier circuit assembly 106 (shown as 106′) is operatively coupled, via the substrate 108 (shown as 108′) (e.g., ground plane), to the antenna circuit assembly 102. In some embodiments, a substrate for the rectifier circuit assembly 106 is stacked onto by the antenna circuit assembly 102 (e.g., with the substrate 108 in the middle of the stack).

The rectifier circuit assembly 106 is configured to receive, from the antenna circuit assembly 102, the harvested electromagnetic energy. To receive the harvested electromagnetic energy, the rectifier circuit assembly 106 includes the radially patterned set of rectifiers 124 (shown as 124′), each rectifier 124a-124n (shown as antenna #1-#N) located in correspondence with a respective antenna 120a-120n, e.g., at a respective one of the signal-receiving locations. In some embodiments, each rectifier 124a-124n is stacked onto by a respective antenna 120a-120n at a respective signal-receiving location. In some embodiments, the coupling between the set of antennas 120 and the set of rectifiers 124 forms a set of rectennas (referred to as a rectenna array).

The rectifier circuit assembly 106 is then configured to generate, via the set of rectifiers 124, the electrical power 112 (e.g., DC power) using the electromagnetic energy harvested by the set of antennas 120. The generated electrical power 112 can be used to power electronic devices (e.g., sensors).

The rectifier circuit assembly 106 can further include one or more filters 130a-130n (shown as filter #1-#N) (e.g., bypass diodes) and a supporting circuit 132 (shown as 132′) (e.g., DC combiner board). In some embodiments, the filters 130a-130n are configured to exclude electrical power generated by rectifiers that use electromagnetic energy (e.g., harvested from respective antennas) below a predefined energy threshold. In some embodiments, the supporting circuit 132 (e.g., DC combiner board) is configured to combine electrical power generated by the set of rectifiers 124a-124n into a single source of electrical power 112. The rectifier circuit assembly 106 with a DC combiner board can be referred to as a summation network or a DC combiner network.

Multi-Lenses and Multi-Assemblies (Multi-Scaled) Configuration. In FIGS. 1E-1F, the exemplary device 100 (e.g. 100e-100f) includes a plurality of antenna circuit assemblies 102a-102n, a plurality of domed lenses 104a-104n, a plurality of of rectifier circuit assemblies 106a-106n, and an additional circuit board 150. In FIG. 1G, the exemplary device 100g includes a dome assembly 170 formed of a plurality of domed lenses 104a-104n.

In FIG. 1E, each of the antenna circuit assemblies 102a-102n is optically coupled, via a respective supporting structure 152a-152n, to a respective one of the domed lenses 104a-104n. Each of the antenna circuit assemblies 102a-102n is further operatively coupled, via a respective one of the substrates 108a-108n (e.g., ground planes), to a respective one of the rectifier circuit assemblies 106a-106n. In some embodiments, a substrate for each of the rectifier circuit assemblies 106a-106n is stacked onto by a respective one of the antenna circuit assemblies 102a-102n, with a respective one of the substrates 108a-108n in the middle of the respective stack. In some embodiments, each of the stacks formed by a respective one of the antenna circuit assemblies 106a, a respective one of the substrates 108a-108n, and a respective one of the rectifier circuit assemblies 106a-106n is operatively coupled (e.g., disposed on) the circuit board 150. The electrical powers (e.g., 112) generated by the stacks can be transmitted, individually or cumulatively, to the circuit board 150 for subsequent use (e.g., powering electronic devices).

In FIG. 1F, the plurality of antenna circuit assemblies 102a-102n and the plurality of rectifier circuit assemblies share the same substrate 108 (e.g., ground plane). Specifically, each of the antenna circuit assemblies 102a-102n is operatively coupled, via the shared substrate 108, to a respective one of the rectifier circuit assemblies 106a-106n. In some embodiments, a substrate for each of the rectifier circuit assemblies 106a-106n is stacked onto by a respective one of the antenna circuit assemblies 102a-102n, with the shared substrate 108 in the middle of the respective stack. In some embodiments, each of the stacks formed by a respective one of the antenna circuit assemblies 106a, the shared substrate 108, and a respective one of the rectifier circuit assemblies 106a-106n is optionally coupled (e.g., disposed on) the circuit board 150.

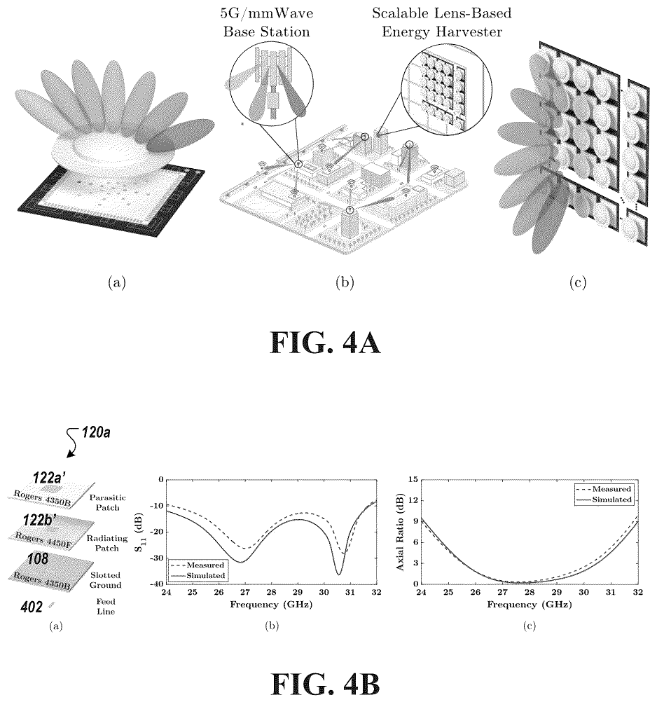

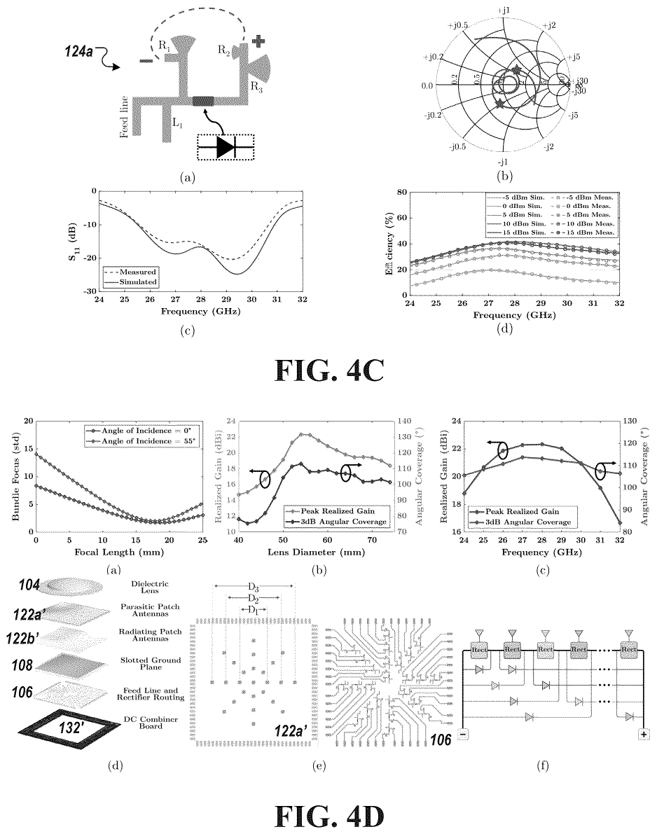

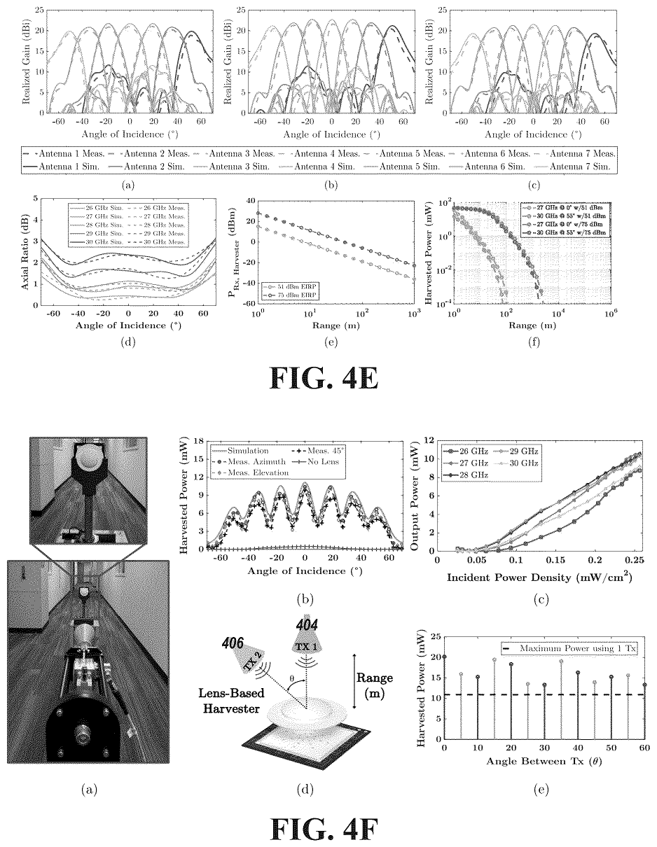

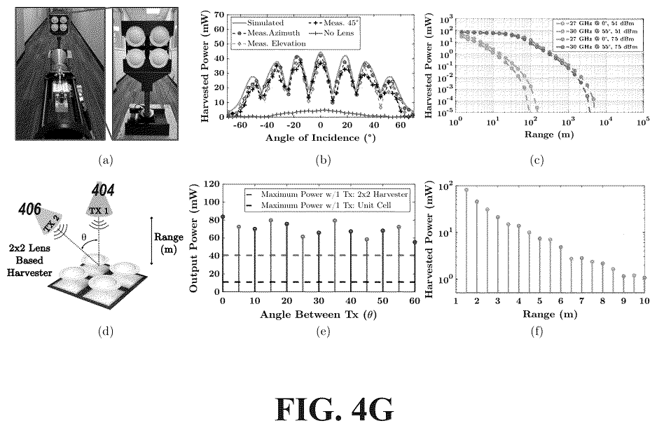

In some embodiments, the exemplary device 100f (e.g., FIG. 4A, subpanel (c)), with multi-lenses and multi-assemblies, is implemented on a power bus 160 to power electronic devices (e.g., sensors) in a smart building (e.g., FIG. 4A, subpanel (b)).

In FIG. 1G, the plurality of domed lenses 104a-104n form the dome assembly 170 that directs electromagnetic signals 110 to every antenna circuit assembly 102a-102n in radial patterns, which are then used to generate the electrical powers (e.g., 112) by a respective rectifier circuit assembly 106a-106n.

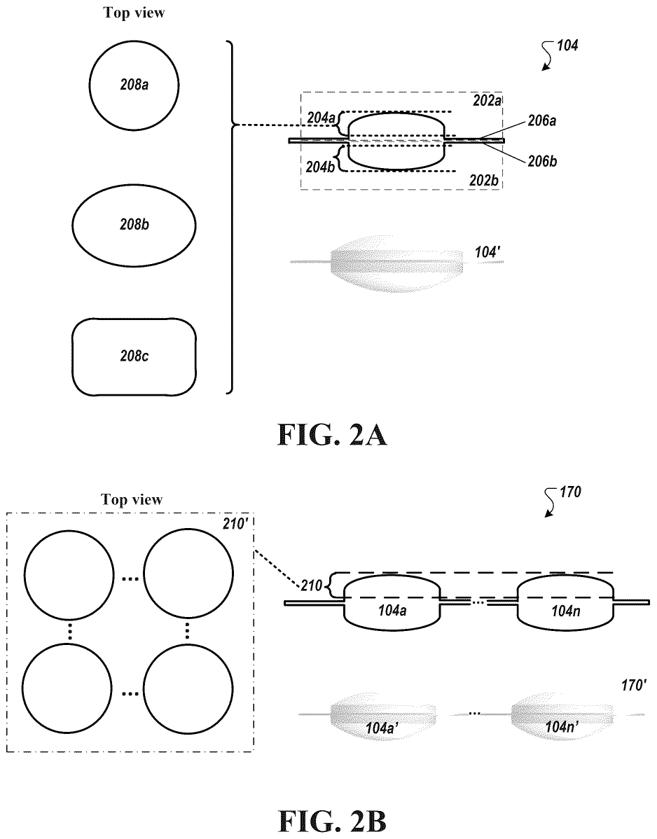

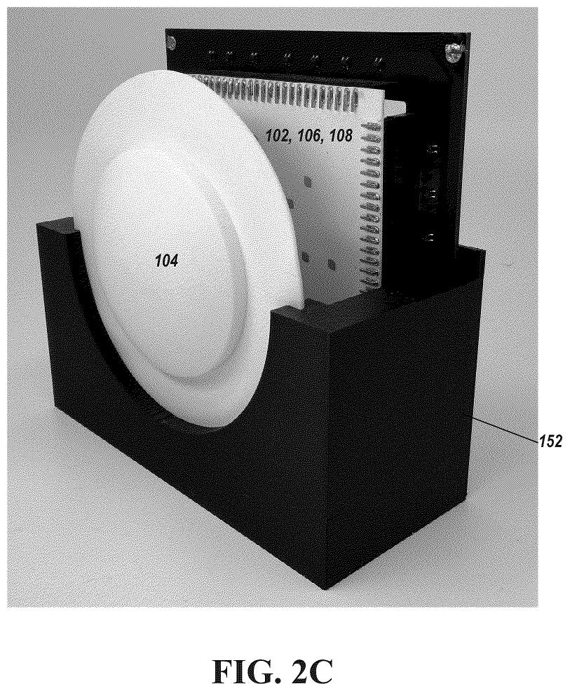

Domed Lens (104). FIG. 2A shows an example domed lens 104 (shown as 104′), in accordance with an illustrative embodiment. As shown, the domed lens 104 is a biconvex dielectric lens having two optical assemblies 202a and 202b, each coupled to the other. The optical assembly 202a includes (i) a curved surface 204a that forms a central region of the assembly 202a, and (ii) a flat surface 206a extending from the curved surface 204a that forms a surrounding region of the central region of the assembly 202a. The optical assembly 202b includes (i) a curved surface 204b that forms a central region of the assembly 202b, and (ii) a flat surface 206b extending from the curved surface 204b that forms a surrounding region of the central region of the assembly 202b.

For the optical assemblies 202a and 202b to be coupled to each other, the flat surface 206a is fixably coupled to the flat surface 206b such that (i) the curved surface 204a is disposed opposite the curved surface 204b and (ii) the central region of the optical assembly 202a is disposed opposite the central region of the optical assembly 202b.

In the domed lens 104, the top view of the curved surface 204a shows a round shape 208a, an elliptical shape 208b, a rounded-corner rectangular shape 208c, or any other shape, depending on the desired angular coverage of electromagnetic signals (e.g., 110). In some embodiments, the domed lens 104 provides angular coverage of at least 550 for the electromagnetic signals (e.g., 110).

FIG. 2B shows an example dome assembly 170 (shown as 170′) comprising a plurality of domed lenses 104a-104n (shown as 104a′-104n′), in accordance with an illustrative embodiment. As shown, the top view 210 (shown as 210′) of the domed assembly 170 is formed of a plurality of top views of the plurality of domed lenses 104a-104n.

FIG. 2C shows an example supporting structure 152 configured to hold the exemplary device (e.g., 100a-100g), in accordance with an illustrative embodiment. As shown, the supporting structure 152 has a set of slots, including a first slot configured to hold the lens 104 and a second slot configured to hold the stacked assemblies (e.g., 102, 106, 108).

### Example Method

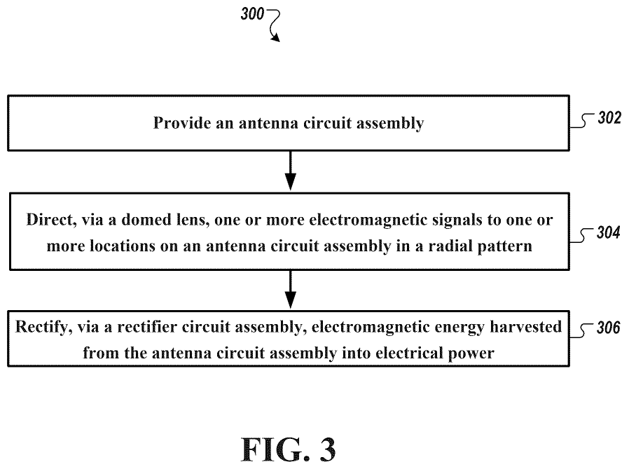

FIG. 3 shows an example method 300 for generating electrical power (e.g., 112) using harvested electromagnetic energy, in accordance with an illustrative embodiment. As shown, the method 300 includes providing (302) an antenna circuit assembly (e.g., 102). The method 300 then includes directing (304), via a domed lens (e.g., 104), one or more electromagnetic signals (e.g., 110) to one or more locations on the antenna circuit assembly (e.g., 102) in a radial pattern. The method 300 then includes rectifying (306), via a rectifier circuit assembly (e.g., 106), electromagnetic energy harvested from the antenna circuit assembly (e.g., 102) into electrical power (e.g., 112) (e.g., DC power), which can be subsequently used to power electronic devices.

In some embodiments, the antenna circuit assembly (e.g., 102) is optically coupled (e.g., via a supporting structure) to the domed lens (e.g., 104). In some embodiments, the antenna circuit assembly (e.g., 102) is further operatively coupled, via a substrate (e.g., 108) (e.g., ground plane), to the rectifier circuit assembly (e.g., 106). The antenna circuit assembly (e.g., 102) and associated set of antennas (e.g., 120) can be stacked on a substrate for the rectifier circuit assembly (e.g., 106) and associated set of rectifiers (e.g., 124), with the ground-plane substrate (e.g., 108) in the middle of the stack.

The antenna circuit assembly (e.g., 102) can include a set of antennas (“antenna array”) (e.g., 120a-120n), each located at a respective one of the locations (“signal-receiving locations”) to which the electromagnetic signals (e.g., 110) are directed. The antennas (e.g., 120a-120n) can form a radial pattern, in which one antenna is located at the center of the radial pattern, and subsequent antennas are located concentrically around the center antenna. In some embodiments, the antenna circuit assembly (e.g., 102) is configured to harvest, via the set of antennas (e.g., 120a-120n), the electromagnetic energy from the electromagnetic signals (e.g., 110).

Each antenna (e.g., 120a-120n) can have at least one substrate/layer (e.g., 122a-122n), including a parasitic patch/layer (e.g., 122a′) and a radiating patch/layer (e.g., 122b′), in which the parasitic patch/layer (e.g., 122a′) is stacked on the radiating patch/layer (e.g., 122b′). In some embodiments, the parasitic layer (e.g., 122a′) is configured to improve the gain or bandwidth of the electromagnetic signals (e.g., 110), and the radiating layer (e.g., 122b′) is configured to harvest the electromagnetic energy from the improved electromagnetic signals for delivery to the rectifier circuit assembly (e.g., 106). In some embodiments, each antenna (e.g., 120a-120b) is circularly polarized and has an axial ratio below 3 dB over a frequency band of 25.5 to 30.5 GHz.

The rectifier circuit assembly (e.g., 106) can include a set of rectifiers (e.g., 124a-124n), each located in correspondence with a respective antenna (e.g., 120a-120n), including at the respective one of the signal-receiving locations on the antenna circuit assembly (e.g., 102). In some embodiments, the rectifier circuit assembly (e.g., 106) is configured to generate, via the set of rectifiers (e.g., 124a-124n), the electrical power (e.g., 112) using the harvested electromagnetic energy. In some embodiments, the rectifier circuit assembly (e.g., 106) includes one or more filters (e.g., 130a-130n) (e.g., bypass diodes) configured to exclude electrical power generated by rectifiers using electromagnetic energy below a predefined energy threshold.

The domed lens (e.g., 104) can be a biconvex dielectric lens having a first optical assembly (e.g., 202a) and a second optical assembly (e.g., 202b), each coupled to the other. In some embodiments, the first optical assembly (e.g., 202a) includes (i) a first curved surface (e.g., 204a) that forms a central region of the first assembly, and (ii) a first flat surface (e.g., 206a) extending from the first curved surface (e.g., 204a) that forms a surrounding region of the central region of the first optical assembly (e.g., 202a).

In some embodiments, the second optical assembly (e.g., 202b) includes (i) a second curved surface (e.g., 204b) that forms a central region of the second optical assembly, and (ii) a second flat surface (e.g., 206b) extending from the second curved surface (e.g., 204b) that forms a surrounding region of the central region of the second optical assembly (e.g., 202b).

For the optical assemblies (e.g., 202a, 202b) to be coupled to each other, the first flat surface (e.g., 206a) is fixably coupled to the second flat surface (e.g., 206b) such that (i) the first curved surface (e.g., 204a) is disposed opposite the second curved surface (e.g., 204b) and (ii) the central region of the first optical assembly (e.g., 202a) is disposed opposite the central region of the second optical assembly (e.g., 202b). Because of the coupling between the optical assemblies (e.g., 202a, 202b), the domed lens (e.g., 104) can provide angular coverage of at least 550 for each of the electromagnetic signals (e.g., 110).

In some embodiments, the domed lens (e.g., 104) is coupled to an actuator (e.g., 140) configured to rotate the domed lens (e.g., 104) over an angle range of 0° to 360°.

### Experimental Result and Additional Examples

A study was conducted to develop an experimental lens-based energy-harvesting device comprising a three-dimensional (3D) biconvex dielectric lens and a circularly polarized patch rectenna array for smart city environments, as described in relation to FIGS. 1-2. While shown for a 50-100 mW device, the lens-based energy-harvesting device can be made larger, applied in an array, or smaller (e.g., <10 mW, <1 mW).

It is contemplated that the three-dimensional (3D) biconvex dielectric lens and array design architecture of the lens-based energy-harvesting device can be applied to various harvester devices, including those described and referenced herein.

The study provided a scalable, broadband, dielectric lens-based mmWave energy harvester with wide total solid angular coverage and mW harvesting capabilities with pixel array of rectennas, each made up of a circularly polarized aperture coupled stacked patch antenna and a broadband high sensitivity rectifier, with a bi-convex dielectric lens to achieve a wide solid angle coverage of 2.68 sr, allowing for effective energy capture across a wide range of angles. The single unit cell harvester achieved a peak captured power up to 11 mW in a proof-of-concept demonstration utilizing a single transmitting source. When scaled to a 2×2 structure, the lens-based rectenna was able to harvest up to 82 mW when utilizing two transmitters, each with incident power density of 0.25 mW/cm2. By achieving both high harvested power and total solid angle coverage, the proposed system surpasses the performance of any existing state-of-the-art broadbeam mmWave energy harvester. When utilizing the full 75 dBm EIRP available at 5G/mmWave, the scaled harvester of the study can theoretically capture a peak power up to 105 mW in addition to harvesting mW levels of power at ranges extending up to 120 m. While the design employs several rectenna elements and diodes, the use of standard multilayer PCB processes and inexpensive dielectric machining ensures the system remains cost-effective. This balance of efficiency, scalability, and orientation-tolerant performance more than offsets the added complexity, yielding a favorable cost-benefit tradeoff Owing to its capability to harvest power over a wide solid-angle coverage, the instant system offers a robust solution for enabling continuous and efficient energy supply in diverse orientations. This characteristic is particularly advantageous for supporting the deployment of next-generation smart city applications, such as distributed sensor networks, autonomous infrastructure monitoring, and communication gateways mounted on buildings, poles, or vehicles, as well as low-power IoT devices operating in dynamic urban environments. Th study finds the system to be the first mmWave ambient energy harvester approaching 100 mW, enabling for the first time the powering of practical devices such as distributed sensing nodes, low-power wireless transceivers, and localization or identification tags directly from harvested energy.

The exemplary device and method of the study can achieve milliwatt (mW)-level harvested power at incident power densities as low as 0.1 mW/cm², with a peak power of 6.5 mW, and maintain mW-level performance across an angular coverage of 2.68 sr, representing the highest combined harvested power across angular coverage among mmWave harvesters. With 5G/mm-Wave equivalent isotropically radiated power (EIRP) of 75 dBm, the exemplary device and method can capture 6.5 mW at 40 m and sustain 1 mW at distances up to 80 m. With broadbeam coverage and efficient energy harvesting, the exemplary device and method can power smart-city applications while reducing reliance on traditional power sources (e.g., solar-panel power).

FIG. 4A shows an experimental energy-harvesting device and its implementation in a smart city. In FIG. 4A, subpanel (a) shows a diagram of the experimental device, subpanel (b) shows a smart city with a dense deployment of the experimental device, and subpanel (c) shows a scalable implementation of the experimental device.

In FIG. 4A, subpanel (a), the experimental device was configured with circularly polarized aperture-coupled stacked patch antennas (e.g., 120a-120n) with small footprints, achieving realized gains up to 22.3 dBi while maintaining broadband circular polarization from 25.5 GHz to 30.5 GHz for stable, angle-resilient operation. The experimental device achieved double the captured power under identical excitation conditions compared to current devices (e.g., [35]), emphasizing the benefit of the antenna-rectifier configuration shown in FIGS. 1A-1G.

In FIG. 4A, subpanel (c), the experimental device was scaled to a 2×2 array, harvesting up to 82 mW under dual-transmitter excitation and sustaining 1 mW at ranges up to 120 m. A passive summation network (e.g., 132′) with bypass diodes (e.g., 130a-130n) in the experimental device ensured that only the most strongly illuminated rectennas contributed, while full-band (e.g., 26 GHz-30 GHz) characterization of gain, axial ratio, and rectifier efficiency confirmed robust performance across the 5G/mmWave band. These configurations established a practical, scalable harvesting device (e.g., experimental device) that provided stronger energy capture, broader angular coverage, and a realistic path toward self-sustaining devices across diverse urban deployments.

Broadbane Aperture-Coupled Stacked Patch-Based Rectenna. A rectenna was configured to combine an antenna (e.g., 120a-120n) that captured incident signals (e.g., radiofrequency (RF)) with a rectifier (e.g., 124a-124n) that generated usable direct current (DC) power, for efficient RF-to-DC conversion. To operate in complex and dynamic environments, the antenna (e.g., 120a-120n) should exhibit high gain over a wide field of view, broadband characteristics, and a straightforward connection to the rectifier (e.g., 124a-124n). To address polarization mismatch and orientation sensitivity, the study implemented circular polarization, which can enable robust power capture across arbitrary tag orientations and in multi-path environments [36]. This capability is beneficial in scenarios where the transmitter orientation cannot be controlled, and allows integration with existing 5G/mmWave infrastructure by being more orientation-tolerant.

To achieve compactness while maintaining broadband performance, the experimental device was configured with a circularly polarized aperture-coupled stacked patch antenna (e.g., 120a-120n) with an operational bandwidth of 24 to 32 GHz. FIG. 4B shows a stackup diagram of a circularly polarized aperture-coupled stacked patch antenna 120a (also referred to as a multi-layer antenna), along with its measured and simulated S₁₁ and axial ratio results.

In FIG. 4B, subpanel (a), the multi-layer antenna 120a included four layers: the parasitic layer 122a′, the radiating layer 122b′, the ground slot 108, and the feed line 402 [37-39]. The stacked parasitic and radiating patches 122a′ and 122b′ were configured to support multiple resonant modes, enhancing the overall bandwidth of the multi-layer antenna 120a. The top parasitic patch 122a′ was not directly fed but enhanced overall antenna performance by increasing gain and widening the bandwidth. Beneath the parasitic patch 122a′, the radiating patch 122b′ captured incoming electromagnetic waves and directed them through the ground slot 108. The ground plane 108 included a slot that coupled energy to the microstrip feed line 402. Circular polarization was achieved by truncating the corners of the patch radiators in the parasitic layer 122a′ and the radiating layer 122b′. In addition to meeting the antenna requirements, the configuration in FIG. 4B separated the antenna and DC signal on different layers, ensuring minimal coupling between the antenna and the rectifier.

The antenna 120a in FIG. 4B, subpanel (a), was simulated in CST Microwave Studio and fabricated using two Rogers 4350B cores (e.g., ϵᵣ=3.66, tan δ=0.0037) with a thickness of 0.254 mm and a Rogers 4450F bondply (ϵᵣ=3.52, tan δ=0.004) with a thickness of 0.2 mm in between. In FIG. 4B, subpanel (b), the return loss of the antenna 120a was measured and compared with simulated results. The measured and simulated results matched, with S₁₁ below −10 dB from 24.5 to 31.5 GHz, enabling broadband performance for the multi-layer antenna 120a.

In FIG. 4B, subpanel (c), to show the circular polarization of the multi-layer antenna 120a, the axial ratio was measured across the operating bandwidth of the antenna 120a and compared with simulated results. The antenna 120a achieved circular polarization over 25.5-30.5 GHz, with the axial ratio remaining below the 3 dB threshold, thus providing the required orientation-tolerant behavior in an optimal harvesting antenna configuration.

In FIG. 4C, subpanel (a) shows a broadband mmWave rectifier in the experimental device, subpanel (b) shows a simulated input impedance of a rectifier matching network with a Schottky diode, subpanel (c) shows measured and simulated S₁₁ results of the rectifier, and subpanel (d) shows measured and simulated power conversion efficiency of the rectifier at input powers from −5 dBm to 15 dBm.

To enable rectification of the received RF energy, the study developed a broadband half-wave rectifier 124a (see FIG. 4C, subpanel (a)). The rectifier 124a included a stub (shown as Li) configured for impedance matching of the input signal, ensuring maximum power transfer between the antenna 120a and the rectifier 124a. The input impedance of the matching network with the Schottky diode (“bypass diode”), plotted on a Smith chart from 24 to 32 GHz (see FIG. 4C, subpanel (b)), confirmed that the impedance was kept close to the center of the chart within the operating band, with markers placed at the lower and upper band edges (e.g., 25.5 and 30.5 GHz), which demonstrated effective matching to the diode across the operating frequencies.

To minimize parasitic caused by signal-to-ground vias, the rectifier 124a included a quarter-wave radial stub (shown as R₁) configured to provide a virtual short circuit at the fundamental frequency while isolating the DC port. A Macom MA4E1317 Schottky diode, selected for its low junction capacitance and low turn-on voltage, which were critical for mmWave operation, was then used to rectify the input RF signal. The rectifier 124a also included a pair of radial stubs, shown as R₂ and R₃, configured for harmonic suppression. Unlike current quarter-wave stubs, which provide narrowband operation, the flared geometry of the radial stubs yielded a wider impedance bandwidth, enabling suppression of diode-generated harmonics across the full 26-30 GHz [36]. This wideband filtering reduced unwanted re-radiation, improved overall conversion efficiency, and ensured stable rectifier performance across the operational frequency band [36].

The rectifier 124a was simulated in Keysight Advanced Design System (ADS) using a nonlinear diode model to optimize impedance matching, harmonic suppression, and DC extraction, and then fabricated using the same Rogers 4350B/4450F stackup as for the aperture-coupled stacked antenna. A resistance sweep from 100Ω to 2 kΩ was performed to determine the optimal load resistance, with 680Ω identified as the best choice. To characterize the rectifier 124a, the return loss was measured at an input power of 0 dBm and compared with simulation results (see FIG. 4C, subpanel (c)). A good match was achieved between the measured and simulated results, confirming broadband performance with return loss below −10 dB from 25.5 GHz to 30.5 GHz.

To further assess efficiency, measurements were taken over the 24-32 GHz range in steps of 0.25 GHz at five input power levels: −5 dBm, 0 dBm, 5 dBm, 10 dBm, and 15 dBm. The measured and simulated results of the efficiency analysis (see FIG. 4C, subpanel (d)) show an agreement across all cases, demonstrating that the rectifier 124a maintained consistent broadband performance and efficient RF-to-DC conversion across the full operating band.

Biconvex Lens-Enabled mmWave Focalization for Broadbeam Energy Harvesting. To enable both high-gain performance and wide total solid angular coverage, the study developed a three-dimensional (3D) biconvex dielectric lens (e.g., 104) to focus incoming mmWave signals (e.g., 110) onto the antenna array (e.g., 120). By directing and focusing the electromagnetic signal, a lens increased the antenna's directivity and efficiency, enabling better signal capture over a wide angular span [40]-[46]. Because the biconvex dielectric lens (e.g., 104) could focus incoming RF signals (e.g., 110) onto the harvesting antennas (e.g., 120a-120n), it was used in the experimental device for energy harvesting, boosting the signal strength, and improving energy capture efficiency [24], [35].

The biconvex dielectric lens (e.g., 104) had three parameters: focal length, surface curvature, and diameter. The focal length determined how wide an angular space the lens could cover, which could be expressed as an angular field of view (AOF), as shown in Equation 1.

$$A O F = 2 arctan ( \frac{h}{F} ) \qquad ( Eq . 1 )$$

In Equation 1, h is the height of the antenna array (e.g., 120) in millimeters (mm), and F is the focal length of the lens in millimeters. Utilizing an antenna topology similar to [35], [44], and to achieve a compact device size, the study set h to 27 mm. By setting a minimum angular field of view of 110°, the lens had a focal length of 17 mm. With this focal length, the front and back curvatures of the lens (e.g., 104) were optimized using ray-tracing Optometrika simulations. The Optometrika simulations, conducted at 27 GHz under normal incidence, identified curvature values that produced a desired focusing behavior of the biconvex dielectric lens (e.g., 104): 55 mm and −55 mm for the front and rear surfaces, respectively, resulting in efficient energy focusing across the lens aperture.

In FIG. 4D, subpanel (a) shows standard deviations of a ray bundle from a back surface of the biconvex dielectric lens 104 at angles of incidence of 0° and 55°, subpanel (b) shows simulated peak realized gain and 3 dB Angular coverage results as a function of diameter of the lens 104 at 27 GHz, subpanel (c) shows simulated peak realized gain at boresight and 3 dB angular coverage as a function of frequency of the lens 104, subpanel (d) shows stackup diagram of the experimental device with the lens 104, subpanel (e) shows top layer 122a′ and bottom layer 106 of the experimental device having 25 circularly polarized rectennas with dimensions D=18 mm, D₂=36 mm, and D₃=54 mm, and subpanel (f) shows a DC combiner network 132′ for the experimental device.

Using the curvatures of 55 mm and −55 mm for the front and rear surfaces, respectively, the standard deviation of the ray bundle intersecting the antenna array (e.g., 120) was recorded at varying focal lengths (see FIG. 4D, subpanel (a)), confirming that the biconvex dielectric lens 104 provided the desired focalization at the focal length of 17 mm.

To evaluate its RF performance, the dielectric lens 104 was modeled in CST Microwave Studio and placed at the 17-mm focal length in front of the aperture-coupled stacked patch antennas (e.g., 120a-120n). The study chose polytetrafluoroethylene (PTFE) (εᵣ=2.10, tan δ=0.001) as the lens material due to its low dielectric losses. To further optimize the lens for both high gain and wide angular coverage, the study performed a parametric sweep of the lens diameter from 40 to 74 mm in 2 mm steps. In FIG. 4D, subpanel (b), the lens with a 54-mm diameter achieved the best compromise between gain and angular coverage, delivering up to 22.7 dBi of realized gain while covering 114°. The study also assessed the broadband performance of the lens 104 via a frequency sweep from 24 to 32 GHz in 1 GHz steps. In FIG. 4D, subpanel (c), the results of the frequency-sweep assessment show that the lens-based antennas (e.g., 120a-120n) maintained over 21 dBi of realized gain and greater than 1100 of angular coverage across 26-30 GHz. These broadband capabilities, combined with the high gain and wide angular coverage, were advantageous for energy harvesting, enabling consistent energy capture from a variety of RF sources across different environments.

Configuration of the Lens-Based Rectenna Array and Power Summation Network. Combining the biconvex dielectric lens 104 and the broadband circularly polarized mmWave rectennas, the study developed the experimental device (e.g., an energy-harvester prototype) (see FIG. 4D, subpanel (d)). The experimental device included 25 rectennas arranged in three concentric circles with diameters of 18, 36, and 54 mm, respectively. Each circle included eight evenly spaced rectennas, with a single additional element positioned at the center of the experimental device (see FIG. 4D, subpanel (e)). An inter-element spacing of 9 mm was selected, as it represents the minimum distance required to minimize coupling between adjacent rectennas while providing sufficient space for routing the DC lines for each rectifier (e.g., 124a-124n) on the bottom layer 106 of the experimental device. Additionally, the configuration enabled the experimental device to achieve a spherical 3 dB angular coverage of 55° around boresight, and to operate effectively regardless of orientation, ensuring consistent performance and coverage across all positions.

To manage the spatially varying power captured across the rectenna array, the study developed a passive power summation network to consolidate the harvested energy while minimizing losses from underilluminated elements. In FIG. 4D, subpanel (f), the network incorporated a diode-based bypass structure, enabling the exclusion of rectennas that received minimal RF power due to the angle of incidence of the transmitting signals. Specifically, (N−1) low-threshold Schottky diodes (e.g., Toshiba 1SS384TE85LF, Vₒₙ≈0.15 V) were used to allow current to circumvent inactive rectifiers, preventing them from impeding the overall output. This arrangement of Schottky diodes ensured that only the two most excited rectennas contributed to the final output, thereby preserving high conversion efficiency across varying incident directions [18], [23]. The summation network operated well with the lens-based configuration, in which the incoming signal was routed to different rectennas based on its incidence angle, enabling orientation-tolerant harvesting.

Characterization of the Experimental Device. To evaluate the radiation performance of the experimental device, a row of broadband multi-layer antennas was fabricated and placed behind the dielectric lens at its focal length of 17 mm. The experimental device was then evaluated in an anechoic chamber using a 20 dBi A-INFO LB-CNH-28-20-D02-C-KF horn antenna as the transmitter in a copolarized configuration.

In FIG. 4E, subpanels (a)-(c) show simulated and measured antenna gain across angles of incidence of the experimental device at operational frequencies of 26 GHz, 28 GHz, and 30 GHz, respectively, subpanel (d) shows simulated and measured axial ratio across angles of incidence from 26 GHz to 30 GHz, subpanel (e) shows the received power impinging onto the experimental device with equivalent isotropic radiated power (EIRP) of 51 dBm and 75 dBm, and subpanel (f) shows the harvested power as a function of range from the experimental device with EIRP of 51 dBm and 75 dBm.

While exciting each rectenna individually, a multibeam array was rotated by ±700 in 1° steps. For each angular step, the gain measurements at 26, 28, and 30 GHz were extracted (see FIG. 4E, subpanels (a)-(c)). An agreement was observed between measurement and simulation at 26, 28, and 30 GHz, with the antenna array (e.g., 120) achieving a 3 dB angular coverage of ±55° and peak realized gains of 21.8 dBi, 22.3 dBi, and 20.5 dBi at the three frequencies, respectively. To further validate the antenna's circular polarization performance across its angular coverage, the study performed axial ratio measurements at five frequencies across the operating bandwidth of the antenna, 26-30 GHz, with 1 GHz steps. The axial ratio measurements were compared with simulation results (see FIG. 4E, subpanel (d)), showing a match between measurements and simulation across the operational bandwidth of the lens-enabled antenna array (e.g., 120), with axial ratios remaining below 3 dB over the 3 dB angular coverage of the experimental device.

Having characterized the experimental broadband lens-enabled device, the study conducted a link budget analysis to demonstrate the experimental device's harvesting capabilities. To demonstrate the maximum performance of the experimental device, the study considered two scenarios for analysis: (i) the device interrogated using a reader, with an EIRP of 51 dBm, and (ii) the device transmitting with an EIRP of 75 dBm, the highest power in 5G/mmWave bands. For the link budget analysis, the study considered two paths: (i) the link from the reader to the experimental device, and (ii) the return link to the reader [47]. The power received on the experimental device could be expressed as shown in Equation 2.

$${P}_{Rx , device} = {P}_{Tx} + {G}_{Tx} + {G}_{Rx} + 10 {n}_{{f}_{0}} {log}_{10} ( \frac{λ}{4 π R} ) \qquad ( Eq . 2 )$$

In Equation 2, P_{Tx} is the transmitting power of the reader in dBm, G_{Tx} is the gain of the transmitting antenna of the radar in dBi, G_{Rx} is the gain of the receiving antenna of the device in dBi, n_{f}_{ₒ} is the path loss exponent of the environment at the fundamental frequency of interrogation that depends on the channel conditions of the wireless link, λ is the wavelength of the operational frequency in meters, and R is the distance of the mmID from the radar in meters.

The power received on the experimental device could also be expressed as shown in Equation 3, where Lₚₐₜₕ is the total path loss at range R.

$${P}_{Rx , Device} = {P}_{Tx} + {G}_{Tx} + {G}_{Rx} - {L}_{path} ( R ) \qquad ( Eq . 3 )$$

In realistic environments, the path loss Lₚₐₜₕ could be modeled using the propagation exponent n_{f}_{ₒ}, as shown in Equation 4. For mmWave links in open environments, n_{f}_{ₒ} has a value of about 2, while for blockage or clutter, n_{f}_{ₒ} has a higher value.

$${L}_{path} = 20 {log}_{10} ( \frac{4 π}{λ} ) + 10 {n}_{f o} {log}_{10} ( R ) \qquad ( Eq . 4 )$$

For the link budget calculation, the study considered two scenarios: (i) a 27 GHz at an incident angle of 0°, and (ii) a 30 GHz at an incident angle of 55°. The study selected the two scenarios to represent the upper and lower bounds of the device's harvesting capability. A 27 GHz signal at normal incidence (e.g., 0°) yielded the highest combined measured antenna gain and rectifier efficiency, establishing it as the upper performance limit. In contrast, a 30 GHz signal at an incidence angle of 55° defined the lower bound, due to a combination of reduced antenna gain, lower rectifier conversion efficiency at this frequency and angle, and a shorter wavelength, resulting in minimal received power at the experimental device (see Equation 2). In FIG. 4E, subpanel (e) shows the incident power impinging on the experimental device as a function of range for each scenario, with the current 51 dBm EIRP and the maximum allowed 75 dBm EIRP.

After impinging on the experimental device, the signal passed through the corresponding rectifier on the device, where the signal was converted from RF to DC to enable the device's harvesting capabilities. The harvested power from the experimental device could then be expressed in mW-scale as shown in Equation 5.

$${P}_{DC} = P C E ( {P}_{Rx , Device} ) \qquad ( Eq . 5 )$$

In Equation 5, PCE(P_{Rx, Device}) is the power conversion efficiency of the broadband rectifier (e.g., 124a-124n), which is a function of the power received by the experimental device in dB scale. The harvested power from the device could also be expressed as shown in Equation 6, where η is the power conversion efficiency, which depends on the frequency f and the input power level. The matching network was configured to optimize power transfer at an operating point. Short-circuited or radial stubs were used to present a virtual RF ground while preserving the DC path.

$${P}_{DC} = η ( {P}_{Rx , Device} , f ) \cdot {P}_{Rx , Device} \qquad ( Eq . 6 )$$

In FIG. 4E, subpanel (f) shows the harvesting performance of the device versus range for each scenario, with the current 51 dBm EIRP and the maximum allowed 75 dBm EIRP conditions. As shown, the experimental device with the reader achieved a maximum harvested power of approximately 19 mW and 10 mW for the best- and worst-case scenarios, respectively. Additionally, the experimental device could harvest more than 1 mW at a reading range of up to 8 m. Moreover, when using the same reader with the maximum allowed EIRP of 75 dBm in 5G/mmWave frequency bands, the experimental device harvested more than 1 mW at a maximum reading range of 180 m and 140 m for the best- and worst-case scenarios, respectively. The 75 dBm scenario represented a maximum permitted under regulations [18]. While not available in ambient conditions, such power levels could be approached in dense mmWave deployments with high-gain transmitters. In the study, the measured results validated practical operation, and the 75 dBm projections were presented as an upper bound on performance.

Single-Unit-Cell Configuration. After characterizing the angular coverage enabled by the RF front end, the study then evaluated the device's harvesting performance in a single-unit-cell configuration. In FIG. 4F, subpanel (a) shows a setup for the evaluation, subpanel (b) shows simulated and measured harvested power across angles of incidence for Azimuth, Elevation, 45° Angular Cuts with and without the lens, subpanel (c) shows measured harvested power and incident power density of the device from 26 to 30 GHz, subpanel (d) shows a conduction of the evaluation, and subpanel (e) shows measured harvested power from the experimental device as a function of angle between the 2 transmitting horn antennas 404 and 406.

In FIG. 4F, subpanel (a), a 28 GHz signal was transmitted from a horn antenna (e.g., 404, 406) to the experimental device at an incident power density of 0.25 mW/cm², with a multimeter attached to the combiner board to monitor the voltage output. The experimental device, with a resistance of 680Ω, was positioned 1.5 m from the transmitter (e.g., 404, 406). To assess the angular harvesting capabilities, the experimental device was mounted on a stepper motor and rotated from ±70° in 3° increments. The study took measurements across multiple angular cuts: azimuth, elevation, and ±45°. The study also performed an angular cut along the azimuth axis without the lens (e.g., 104) to highlight its contribution to performance.

In FIG. 4F, subpanel (b), the evaluation results revealed an enhancement in harvested power due to the lens (e.g., 104), with power variations corresponding to the beamwidth of each illuminated rectenna. The power variations arise from the lens (e.g., 104) focalizing energy onto individual rectennas in sequence, producing distinct peaks as the angle of incidence shifts across the row. While a flatter response could be achieved by configuring the device for weaker focalization, this would reduce realized gain and lower the peak harvested power. The device configuration in the study, therefore, prioritized maximizing gain and captured power while maintaining robust harvesting performance across a wide angular range. The experimental device achieved a peak harvested power up to 11 mW at boresight, with seven distinct peaks, each corresponding to one of the rectennas along the array, resulting in angular coverage of ±55°. The measurements also demonstrated consistent performance across all four angular cuts, demonstrating the device's orientation-tolerant behavior.

The study then evaluated the performance of the device across a range of incident power densities. An 836640L Signal Generator produced a transmitted signal, which was amplified by an AHP2850-18-3024 power amplifier and a QPA2212 amplifier. The amplified signal was then fed into a 20 dBi circularly polarized conical horn antenna and transmitted to the experimental device. Considering cable losses, the device's maximum total EIRP was measured at 49 dBm. The experimental device then converted the RF signal to DC power, and the resulting voltage was measured across the load using a B&K Precision 5492C multimeter. To evaluate the device's broadband capabilities, the study conducted measurements across the frequency range of 26 to 30 GHz in 1 GHz increments, with the EIRP of the transmitted signal varied from 38 dBm to 49 dBm. The results, shown in FIG. 4F, subpanel (c), demonstrated that the experimental device harvested power above 1 mW at incident power densities as low as 0.08 mW/cm², exceeded 10 mW between 27 and 29 GHz when the incident power density increased to 0.25 mW/cm².

To further assess the device's wide angular coverage and the effectiveness of the power summation network, the study conducted a multi-transmitter experiment. In FIG. 4F, subpanel (d), two transmitting antennas 404 and 406 were positioned 1.5 m from the device, each delivering an identical power density of 0.25 mW/cm⁻². In the multi-transmitter experiment, both horns 404 and 406 were supplied by a single RF generator through a power splitter. The experimental device did not depend on the relative phase of the signals, and the DC summation network combined the contributions from the illuminated rectennas, making the configuration of the experiment equivalent to that of multiple independent transmitters, where the combiner ensured that all incident power was delivered to the output.

Unlike communication receivers that rely on coherent detection, the rectifier (e.g., 124a-124n) operated based on the total received power. Any phase difference between transmitters 404 and 406 affected only the instantaneous RF field, not the average incident power at the aperture. As a result, the harvested output remained determined by the combined power density rather than the relative phase between sources. One antenna (e.g., 404) was kept aligned along the device's boresight, while the other (e.g., 406) was rotated to create incidence angles from 0 to 60°. The results in FIG. 4F, subpanel (e), revealed that the experimental device achieved a peak harvested power of 20 mW when both transmitters 404 and 406 were aligned at boresight, while still maintaining up to 13 mW harvested power at 60°. Additionally, the dual-transmitter configuration resulted in higher harvested power than the single-transmitter setup (see FIG. 4F, subpanel (a)), emphasizing the advantages of the power summation network and demonstrating the experimental device's ability to harvest energy from a wide range of incident angles.

Scaled 2×2 Configuration. After evaluating the single-unit-cell configuration, the study developed a 2×2 configuration for the experimental device. In FIG. 4G, subpanel (a) shows an evaluation setup of the scaled 2×2 configuration, subpanel (b) shows simulated and measured harvested power across angles of incidence for Azimuth, Elevation, 45° Angular Cuts with and without the lenses, subpanel (c) shows harvested power as a function of range from the 2×2 configuration, with EIRP of 51 dBm and 75 dBm, subpanel (d) shows a conduction of the evaluation of the 2×2 configuration, subpanel (e) shows measured harvested power from the 2×2 configuration as a function of angle between the two transmitting horn antennas 404 and 406, and subpanel (f) shows measured harvested power from the 2×2 configuration as a function range.

For a uniform illumination across the full aperture of the array (e.g., 120), the minimum distance between the transmitter (e.g., 404, 406) and the 2×2 configuration of the experimental device was determined based on the transmitter's 3 dB beamwidth and the array's diagonal aperture size, which could be expressed as shown in Equation 7.

$${d}_{min} = \frac{{L}_{diag}}{2 tan ( \frac{{θ}_{3 dB}}{2} )} \qquad ( Eq . 7 )$$

In Equation 7, L_{diag} is the diagonal length of the 2×2 configuration and θ_{3 dB} is the beamwidth of the transmitting horn antenna (e.g., 404, 406). Utilizing an L_{diag} of 140 mm and a θ_{3 dB} of 6.5°, the minimum distance, denoted as dₘᵢₙ, from the experimental device was 1.23 m. To evaluate the scaled 2×2 configuration, the study conducted an angular coverage test, similar to that conducted for the single-unit-cell configuration, across each angular cut. The study placed the experimental device 1.5 m from the transmitter (e.g., 404, 406), ensuring that the entire aperture of the scaled configuration was illuminated, and rotated from ±70° in 3° increments. Utilizing a 28 GHz signal with an incident power density of 0.25 mW/cm², the results from this evaluation (see FIG. 4G, subpanel (b)) show the advantage of scaling, as the experimental device achieved (i) a maximum harvested power up to 41 mW, and (ii) greater than 15 mW across the device's 3 dB angular coverage of ±55°. Similar results were achieved across the device's 3 angular cuts (see FIG. 4G, subpanel (b)), further showing the orientation-tolerant properties of the 2×2 configuration.

Based on the results in FIG. 4G, subpanel (b), the study conducted a link budget analysis of the scaled configuration. Utilizing the same upper and lower limits of the device, 27 GHz at an incident angle of 0° and 30 GHz at an incident angle of 55°, the study conducted the link budget analysis using the current reader's EIRP of 51 dBm and the maximum 5G/mmWave EIRP of 75 dBm. In FIG. 4G, subpanel (c) shows the devices' harvesting capability as a function of range. Using the same transmitting system (see FIG. 4G, subpanel (a)) with the maximum EIRP of 75 dBm in the 5G/mmWave frequency bands, the 2×2 configuration had a peak harvested value of 105 mW, in addition to harvesting greater than 1 mW at a maximum reading range of 120 m and 80 m, for the best and worst case scenarios, respectively, which demonstrated the potential for long-range wireless power transfer applications.

In FIG. 4G, subpanel (d), the multitransmitter (e.g., 404, 406) was repeated in the scaled configuration to further demonstrate the experimental device's passive power summation network and wide angular coverage, with each antenna (e.g., 404, 406) transmitting a 28 GHz signal at an incident power density of 0.25 mW/cm². In FIG. 4G, subpanel (e), the evaluation results show that the experimental device achieved a peak harvested power of up to 82 mW, exceeding 60 mW when the angle between the transmitters, denoted as θ, varied from 0 to 60°.

To demonstrate the long-distance harvesting capabilities of the rectennas, both horn antennas 404 and 406 of the multi-transmitter setup (see FIG. 4G, subpanel (d)) were placed at boresight to the scaled configuration. The experimental device was then ranged from 1.5 to 10 m, in steps of 0.5 m, with the harvested power measured at each step. In FIG. 4G, subpanel (f), the evaluation results show that with the scaled configuration, the experimental device harvested more than 1 mW up to 10 m away, making it the longest-ranged mmWave harvester.

### DISCUSSION

With advances in smart city technologies and deployments of 5G wireless networks, more than 80 billion low-power IoT devices are expected to interact with urban infrastructure by the end of 2025 [1]. Low-power IoT devices enable next-generation urban sensing networks that deploy sensor nodes throughout the urban environment to monitor and optimize key systems in real time. These sensor networks support various applications, including traffic flow regulation, environmental monitoring, energy management, and public safety [2]-[4], providing continuous, data-driven insights to improve efficiency, reduce operational costs, and increase sustainability. However, a proportional number of batteries would be required to power these distributed devices, thereby increasing the manufacturing, environmental, and maintenance costs of smart cities and impeding their adoption.

RF energy harvesting provides a scalable alternative by eliminating the reliance on batteries and reducing maintenance overhead. RF harvesters convert incident radio frequency (RF) energy from the surrounding wireless environment into usable electrical power to drive low-power circuitry [5]-[11]. The RF harvesters experience low equivalent isotropic radiated power (EIRP), limiting their performance in dense deployments [12]-[16]. Additionally, the low incident power densities reduce the available energy, and the large size of current harvesters limits their practicality, especially in complex urban settings.

By shifting to millimeter-wave (mmWave) energy harvesting, the wide bandwidth and increased EIRP available in 5G/mmWave bands enable dense spatial multiplexing of IoT devices throughout a city. Licensed 5G base stations operating in the 28 39 GHz range can emit directional beams with equivalent isotropically radiated power (EIRP) up to 75 dBm, as permitted by the Federal Communications Commission [17], [18]. While some compact harvesters at lower frequencies achieve small form factors, broad coverage, and orientation-agnostic performance, their gains are limited by their longer wavelengths, which restrict both the harvested power and the effective operating range [19-22]. In contrast, the shorter wavelengths at mmWave frequencies enable higher gain in a compact design, which, together with the high-EIRP mmWave infrastructure, supports long-range wireless power transfer and the dense deployment of IoT nodes in smart city environments. This focused delivery enhances the efficiency of wireless power transfer and supports longer range operation [18], [23-30]. The short wavelength of mmWave signals also allows for the use of compact, high-gain antennas suitable for small-form-factor sensor nodes. Furthermore, the beamforming and directional steering features of mmWave transmission enable spatial targeting of power to specific sensors, improving performance even in challenging deployment scenarios. As 5G infrastructure continues to densify, the growing availability of high-power mmWave sources enables a ubiquitous power-delivery platform for future battery-free systems in smart cities.

Recent developments in harvesters with lens-enabled antennas provide enhanced angular coverage and gain [18], [24], [31]-[34]. However, these harvesters exhibited poor efficiency when powered by a single transmitter, limiting their ability to harvest power over their full solid angle. Thus, there is a need for orientation-tolerant energy harvesters that combine high gain and wide angular coverage with efficient rectifiers to achieve greater harvested power. Achieving consistent power capture under movement or misalignment remains critical for practical deployment. Addressing this challenge requires orientation-tolerant designs that combine high gain, wide angular coverage, and efficient rectification.

### CONCLUSION

The construction and arrangement of the systems and methods, as shown in the various implementations, are illustrative only. Although only a few implementations have been described in detail in this disclosure, many modifications are possible (e.g., variations in sizes, dimensions, structures, shapes, proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special-purpose computer processor for an appropriate system, incorporated for this or another purpose, or by a hardwired system. Implementations within the scope of the present disclosure include program products, including machine-readable media for carrying or having machine-executable instructions or data structures stored thereon. Such machine-readable media can be any available media that can be accessed by a general-purpose or special-purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium; thus, any such connection is properly termed a machine-readable medium. Combinations of the above are also included within the scope of machine-readable media. Machine-executable instructions include, for example, instructions and data that cause a general-purpose computer, special-purpose computer, or special-purpose processing machine to perform a certain function or group of functions.

It is to be understood that the methods and systems are not limited to specific synthetic methods, specific components, or particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference to each various individual and collective combinations and permutations of these may not be explicitly disclosed, each is specifically contemplated and described herein, for all methods and systems. This applies to all aspects of this application, including, but not limited to, steps in disclosed methods. Thus, if there are a variety of additional steps that can be performed, it is understood that each of these additional steps can be performed with any specific implementation or combination of implementations of the disclosed methods.

The following patents, applications, and publications, as listed below and throughout this document, are hereby incorporated by reference in their entirety herein.
[1] Brooks, C. Growing cyberthreats to the internet of things (2025).
[2] Rahmani, H. et al. Next-generation IoT devices: Sustainable, eco-friendly manufacturing, energy harvesting, and wireless connectivity. IEEE J. Microwaves 3, 237-255. https://doi.org/10.1109/JMW.2022.3228683 (2023).
[3] Fuller, A., Fan, Z., Day, C. & Barlow, C. Digital twin: Enabling technologies, challenges and open research. IEEE Access 8, 108952-108971. https://doi.org/10.1109/ACCESS.2020.2998358 (2020).
[4] Shafique, K., Khawaja, B. A., Sabir, F., Qazi, S., & Mustaqim, M. Internet of Things (IoT) for Next-Generation Smart Systems: A Review of Current Challenges, Future Trends, and Prospects for Emerging 5G-IoT Scenarios. IEEE Access 8, 23022-23040. https://doi.org/10.1 109/ACCESS.2020.2970118 (2020).
[5] Valenta, C. R. & Durgin, G. D. Harvesting wireless power: Survey of energy-harvester conversion efficiency in far-field, wireless power transfer systems. IEEE Microw. Mag. 15, 108-120. https://doi.org/10.1109/MMM.2014.2309499 (2014).
[6] Clerckx, B., Kim, J., Choi, K. W. & Kim, D. I. Foundations of wireless information and power transfer: Theory, prototypes, and experiments. Proc. IEEE 110, 8-30. https://doi.org/10.1109/JPROC.2021.3132369 (2022).
[7] Brown, W. The history of power transmission by radio waves. IEEE Transactions on Microw. Theory Tech. 32, 1230-1242. https://d oi.org/10.1109/TMTT.1984.1132833 (1984).
[8] Shinohara, N. Power without wires. IEEE Microw. Mag. 12, S64-S73. https://doi.org/10.1109/MMVIM.2011.942732 (2011).
[9] Shinohara, N. History and innovation of wireless power transfer via microwaves. IEEE J. Microwaves 1, 218-228. https://doi.org/1 0.1109/JMW.2020.3030896 (2021).
[10] Kim, S. et al. Ambient RF energy-harvesting technologies for self-sustainable standalone wireless sensor platforms. Proc. IEEE 102, 1649-1666. https://doi.org/10.1109/JPROC.2014.2357031 (2014).
[11] Niotaki, K. et al. RF energy harvesting and wireless power transfer for energy autonomous wireless devices and rfids. IEEE J. Microwaves 3, 763-782. https://doi.org/10.1109/JMW.2023.3255581 (2023).
[12] Shafique, K. et al. Energy harvesting using a low-cost rectenna for Internet of Things (IoT) applications. IEEE Access 6, 30932-30941. https://doi.org/10.1109/ACCESS.2018.2834392 (2018).
[13] Visser, H. J., Reniers, A. C. F. & Theeuwes, J. A. C. Ambient RF energy scavenging: GSM and WLAN power density measurements. In 2008, 38th European Microwave Conference, 721-724, https://doi.org/10.1109/EUMC.2008.4751554 (2008).
[14] Vyas, R. J., Cook, B. B., Kawahara, Y., & Tentzeris, M. M. E-wehp: A batteryless embedded sensor-platform wirelessly powered from ambient digital-tv signals. IEEE Transactions on Microw. Theory Tech. 61, 2491-2505. https://doi.org/10.1109/TMTT.2013.2258168 (2013).
[15] Andersson, M. A. et al. Feasibility of ambient RF energy harvesting for self-sustainable M2M communications using transparent and flexible graphene antennas. IEEE Access 4, 5850-5857. https://doi.org/10.1109/ACCESS.2016.2604078 (2016).
[16] Graham, A. M., Daskalakis, S. N., Fusco, V., Tentzeris, M. M. & Asimonis, S. D. A highly efficient, scalable, tetra-band metamaterial-based ambient RF energy harvester. IEEE Transactions on Microw. Theory Tech. 1-12, https://doi.org/10.1109/TMTT.2025.3555848 (2025).
[17] Federal Communications Commission. Use of spectrum bands above 24 ghz for mobile radio services. Tech. Rep. FCC 17-152, Federal Communications Commission, Washington, DC, USA (2018). P. 49, https://www.govinfo.gov/content/pkg/FR-2018-01-0 2/pdf/2017-27437.pdf.
[18] Eid, A., Hester, J. G., & Tentzeris, M. M. 5 g as a wireless power grid. Sci. Reports 11, https://doi.org/10.1038/s41598-020-79500-x (2021).
[19] Zhang, X., Cao, C. & Song, C. A compact dual-band dual-circular-polarization wideband rectenna using a reverse Wilkinson power divider for wireless information and power transfer. IEEE Antennas Wirel. Propag. Lett. 23, 2728-2732. https://doi.org/10.1109/L AWP.2024.3405579 (2024).
[20] Kumar, M. & Sharma, A. A compact planar multisector rectenna array with full-wave rectification for 3-D uniform wireless powering of IoT nodes. IEEE Transactions on Antennas Propag. 73, 3470-3480. https://doi.org/10.1109/TAP.2025.3542971 (2025).
[21] Song, C. et al. A novel six-band dual CP rectenna using improved impedance matching technique for ambient RF energy harvesting. IEEE Transactions on Antennas and Propag. 64, 3160-3171. https://doi.org/10.1109/TAP.2016.2565697 (2016).
[22] Fezai, F. et al. Low-profile dual-band circularly polarized microstrip antenna for GNSS applications. In 2015 9th European Conference on Antennas and Propagation (EuCAP), 1-4 (2015).
[23] Eid, A., Hester, J. & Tentzeris, M. M. Extending the range of 5 g energy transfer: Towards the wireless power grid. In 2022 16th European Conference on Antennas and Propagation (EuCAP), 1-4, https://doi.org/10.23919/EuCAP53622.2022.9769572 (2022).
[24] Deng, F. & Luk, K. M. A broadband high-gain multibeam ambient millimeter-wave energy-harvesting system. IEEE Internet Things J. 11, 4888-4898. https://doi.org/10.1109/JIOT.2023.3301536 (2024).
[25] 25. Jiang, B., Li, P., Zheng, S., Lin, Y. & Xu, H. A 24-GHz beam-steerable multinode wireless power transfer system with a maximum DC output of 5.7 dBm at 1 m distance. IEEE Transactions on Microw. Theory Tech. 1-16, https://doi.org/i0.1109/TMTT.2024.3402067 (2024).
[26] Wagih, M., Hilton, G. S., Weddell, A. S., & Beeby, S. Broadband millimeter-wave textile-based flexible rectenna for wearable energy harvesting. IEEE Transactions on Microw. Theory Tech. 68, 4960-4972. https://doi.org/10.1109/TMTT.2020.3018735 (2020).
[27] Bito, J. et al. Millimeter-wave ink-jet printed RF energy harvester for next-generation flexible electronics. In 2017 IEEE Wireless Power Transfer Conference (WPTC), 1-4, https://doi.org/10.1109/WPT.2017.7953871 (2017).
[28] Ladan, S., Guntupalli, A. B., & Wu, K. A high-efficiency 24 GHz rectenna development towards millimeter-wave energy harvesting and wireless power transmission. IEEE Transactions on Circuits Syst. I: Regul. Pap. 61, 3358-3366. https://doi.org/10.1109/TCSI.2 014.2338616 (2014).
[29] Ladan, S. & Wu, K. 35 GHz harmonic harvesting rectifier for wireless power transmission. In 2014 IEEE MTT-S International Microwave Symposium (IMS2014), 1-4, https://doi.org/10.1109/MWSYM.2014.6848572 (2014).
[30] Zhang, H., Li, D., Wang, Z., Liu, Y. & Shinohara, N. A high-efficiency mmwave rectifier based on substrate-integrated suspended lines. IEEE Microw. Wirel. Technol. Lett. 1-4, https://doi.org/10.1109/LMWT.2025.3556671 (2025).
[31] Shao, W., Yang, B. & Shinohara, N. 3D-printed multifocusing truncated Gutman lens with highly efficient mmIC class-F load GaAs rectenna for mm-wave battery-free IoT application. IEEE Transactions on Components, Packag. Manuf Technol. 14, 1319-1325. https://doi.org/10.1109/TCPMT.2024.3419712 (2024).
[32] 32. Hobballah, A.-H., Negrier, R. & Lalande, M. A dielectric lens rectenna for wireless power transmission. In 2021, 51st European Microwave Conference (EuMC), 672-675, https://doi.org/10.23919/EuMC50147.2022.9784274 (2022).
[33] Shao, W. et al. Graded-index-fiber-inspired 3-D printed surface focusing porous dielectric structure with GaAs mmIC rectenna toward millimeter-wave wireless power transfer application. IEEE Antennas Wirel. Propag. Lett. 22, 3177-3181. https://doi.org/10 0.1109/LAWP.2023.3312691 (2023).
[34] Majumder, B., Vinnakota, S. S., Upadhyay, S. & Kandasamy, K. Dielectric metasurface inspired directional multi-port Luneburg lens as a medium for 5 G wireless power transfer—a design methodology. IEEE Photonics J. 14, 1-10. https://doi.org/10.1109/JPHO T.2022.3169711 (2022).
[35] Joshi, M., Hu, K., Lynch, C. A., & Tentzeris, M. M. Toward 5 G wireless power harvesting: A promising broadbeam equiconvex lens-integrated mmwave harvester for smart city environments. IEEE Microw. Wirel. Technol. Lett. 35, 904-907. https://doi.org/10.110 9/LMWT.2025.3570677 (2025).
[36] Balanis, C. A. Antenna theory: Analysis and design (Wiley, 2016).
[37] Targonski, S., Waterhouse, R. & Pozar, D. Design of wide-band aperture-stacked patch microstrip antennas. IEEE Transactions on Antennas and Propag. 46, 1245-1251. https://doi.org/10.1109/8.719966 (1998).
[38] 38. Bhutani, A. et al. 122 GHz aperture-coupled stacked patch microstrip antenna in LTCC technology. In 2016 10th European Conference on Antennas and Propagation (EuCAP), 1-5, https://doi.org/10.1109/EuCAP.2016.7481147 (2016).
[39] Targonski, S. & Waterhouse, R. An aperture-coupled stacked patch antenna with 50% bandwidth. In the IEEE Antennas and Propagation Society International Symposium. 1996 Digest, vol. 1, 18-21 vol. 1, https://doi.org/10.1109/APS.1996.549532 (1996).
[40] Schoenlinner, B., Wu, X., Ebling, J., Eleftheriades, G., & Rebeiz, G. Wide-scan spherical-lens antennas for automotive radars. IEEE Transactions on Microw. Theory Tech. 50, 2166-2175. https://doi.org/10.1109/TMTT.2002.802331 (2002).
[41] Rebeiz, G. Millimeter-wave and terahertz integrated circuit antennas. Proc. IEEE 80, 1748-1770. https://doi.org/10.1109/5.175253 (1992).
[42] Lynch, C. A., Soto-Valle, G., Hester, J., & Tentzeris, M. M. mmids enter the 3rd dimension: A camera-inspired broadbeam high-gain retrodirective backscatter tag. In 2023 IEEE/MTT-S International Microwave Symposium—IMS 2023, 1069-1072, https://doi.org/1 0.1109/IMS37964.2023.10188156 (2023).
[43] Lynch, C. A., Soto-Valle, G., Hester, J. G. D., & Tentzeris, M. M. At the intersection between optics and mmwave design: An energy autonomous 5 g-enabled multilens-based broadbeam mmid for “smart” digital twins applications. IEEE Transactions on Microwave Theory and Techniques 72, 2620-2630. https://doi.org/10.1109/TMTT.2023.3344538 (2024).
[44] Joshi, M., Lynch, C. A., Hu, K., Soto-Valle, G., & Tentzeris, M. M. A fully-passive frequency diverse lens-enabled mmid for precise ranging and 2-axis orientation detection in next-generation IoT and cyberphysical systems. IEEE J. Radio Freq. Identif 8, 788-800. https://doi.org/10.1109/JRFID.2024.3477919 (2024).
[45] Joshi, M., Hu, K., Lynch, C. A. & Tentzeris, M. M. Achieving quasi-planar coverage: A concave meniscus lens-enhanced rotmanlens-based mmid for ultra-long-range iot applications. IEEE Antennas Wirel. Propag. Lett. 24, 741-745. https://doi.org/10.1109/L AWP.2024.3514914 (2025).
[46] Joshi, M. et al. Advancing self-sustainable ultralong-range microlocalization: A fully passive multibeam harmonic mmid with extended angular coverage for next-generation IoT infrastructures. IEEE Transactions on Microw. Theory Tech. 1-14, https://doi.or g/10.1109/TMTT.2025.3614087 (2025).
[47] Griffin, J. D. & Durgin, G. D. Complete link budgets for backscatter-radio and RFID systems. IEEE Antennas Propag. Mag. 51, 11-25. https://doi.org/10.1109/MAP.2009.5162013 (2009).
[48] A. Manoharan, “Council post: 5 industries that will be impacted by iot in the upcoming years,” October 2024. [Online]. Available: https://www.forbes.com/councils/forbestechcouncil/2024/10/17/5-industries-that-will-be-impacted-by-iot-in-the-upcoming-years/
[49] J. Kimionis, A. Georgiadis, S. N. Daskalakis, and M. M. Tentzeris, “A printed millimetre-wave modulator and antenna array for backscatter communications at gigabit data rates,” Nature Electronics, vol. 4, no. 6, p. 439-446, June 2021.
[50] A. Eid, J. Hester, and M. M. Tentzeris, “Extending the range of 5 g energy transfer: Towards the wireless power grid,” in 2022 16th European Conference on Antennas and Propagation (EuCAP), 2022, pp. 1-4.

What is claimed:

1. A device comprising:
an antenna circuit assembly;
a domed lens optically coupled to the antenna circuit assembly, the domed lens being configured to direct one or more electromagnetic signals to one or more locations on the antenna circuit assembly in a radial pattern; and
a rectifier circuit assembly operatively coupled to the antenna circuit assembly, the rectifier circuit assembly being configured to rectify electromagnetic energy harvested from the antenna circuit assembly.

2. The device of claim 1, wherein the antenna circuit assembly comprises a set of antennas, each being located at a respective location of the one or more locations, and wherein the antenna circuit assembly is configured to:
harvest, via the set of antennas, the electromagnetic energy from the one or more electromagnetic signals at the one or more locations.

3. The device of claim 2, wherein each antenna in the set of antennas comprises at least one substrate, including a first substrate and a second substrate, wherein the first substrate is stacked on the second substrate,
wherein the first substrate is configured to improve a gain or bandwidth of the one or more electromagnetic signals, and
wherein the second substrate is configured to harvest the electromagnetic energy from the improved one or more electromagnetic signals for delivery to the rectifier circuit assembly.

4. The device of claim 2, wherein the rectifier circuit assembly comprises a set of rectifiers, each being located in correspondence with a respective antenna in the set of antennas, and wherein the rectifier circuit assembly is configured to:
generate, via the set of rectifiers, an electrical power using the harvested electromagnetic energy, wherein the generated electrical power is subsequently used for powering electronic devices.

5. The device of claim 1, wherein the domed lens is a biconvex dielectric lens comprising:
a first optical assembly comprising:
a first curved surface forming a central region of the first optical assembly, and
a first flat surface extending from the first curved surface, wherein the first flat surface forms a surrounding region of the central region of the first optical assembly; and
a second optical assembly comprising:
a second curved surface forming a central region of the second optical assembly, and
a second flat surface extending from the second curved surface, wherein the second flat surface forms a surrounding region of the central region of the second optical assembly,
wherein the first flat surface is fixably coupled to the second flat surface such that (i) the first curved surface is disposed opposite the second curved surface and (ii) the central region of the first optical assembly is disposed opposite the central region of the second optical assembly.

6. The device of claim 2, wherein antennas in the one set of antennas form the radial pattern comprising one antenna located at a center of the radial pattern and subsequent antennas located concentrically around the center of the radial pattern.

7. The device of claim 3, wherein the at least one substrate of each antenna in the set of antennas is stacked on a substrate for a respective rectifier in the set of rectifiers.

8. The device of claim 1, wherein the antenna circuit assembly is configured to receive the directed one or more electromagnetic signals across a frequency band of 25.5 to 30.5 GHz.

9. The device of claim 2, wherein each antenna in the set of antennas is a circularly polarized antenna configured with an axial ratio below 3 dB across a frequency band of 25.5 to 30.5 GHz.

10. The device of claim 1, wherein the domed lens provides an angular coverage of at least 550 for each of the one or more electromagnetic signals.

11. The device of claim 1, further comprising:
an actuator operatively coupled to the domed lens, wherein the actuator is configured to actuate the domed lens across angles of 0° to 360°.

12. The device of claim 3, wherein the rectifier circuit assembly further comprises:
one or more filters configured to exclude electrical power generated by rectifiers using electromagnetic energy below a predefined energy value.

13. The device of claim 2, further comprising:
a second antenna circuit assembly;
a second domed lens optically coupled to the second antenna circuit assembly, the second domed lens being configured to direct the one or more electromagnetic signals to second one or more locations on the second antenna circuit assembly in a second radial pattern; and
a second rectifier circuit assembly operatively coupled to the second antenna circuit assembly, the second rectifier circuit assembly being configured to rectify second electromagnetic energy harvested from the second antenna circuit assembly.

14. The device of claim 13, wherein the second antenna circuit assembly comprises a second set of antennas, each being located at a respective location of the second one or more locations, and wherein the second antenna circuit assembly is configured to:
harvest, via the second set of antennas, the second electromagnetic energy from the one or more electromagnetic signals at the second one or more locations.

15. The device of claim 14, wherein each antenna in the second set of antennas comprises at least one substrate, including a third substrate and a fourth substrate, wherein the third substrate is stacked on the fourth substrate,
wherein the third substrate is configured to improve gain or bandwidth of the one or more electromagnetic signals, and
wherein the fourth substrate is configured to harvest the second electromagnetic energy from the improved one or more electromagnetic signals for delivery to the second rectifier circuit assembly.

16. The device of claim 15, wherein the second rectifier circuit assembly comprises a second set of rectifiers, each being located in correspondence with a respective antenna in the second set of antennas, and wherein the second rectifier circuit assembly is configured to:
generate, via the second set of rectifiers, a second electrical power using the harvested second electromagnetic energy, wherein the generated second electrical power is subsequently used for powering electronic devices.

17. The device of claim 16, wherein the generated electrical power and the generated second electrical power are combined to be used for powering the electronic devices.

18. A device comprising:
at least two antenna circuit assemblies, including a first circuit assembly and a second circuit assembly;
at least two domed lenses, including a first domed lens optically coupled to the first antenna circuit assembly and a second domed lens optically coupled to the second antenna circuit assembly, wherein the first domed lens is operatively coupled to the second domed lens,
wherein the first domed lens is configured to direct one or more electromagnetic signals to first one or more locations on the first antenna circuit assembly in a first radial pattern, and
wherein the second domed lens is configured to direct the one or more electromagnetic signals to second one or more locations on the second antenna circuit assembly in a second radial pattern; and
at least two rectifier circuit assemblies, including a first rectifier circuit assembly operatively coupled to the first antenna circuit assembly and a second rectifier circuit assembly operatively coupled to the second antenna circuit assembly, wherein the first rectifier circuit assembly is configured to rectify first electromagnetic energy harvested from the first antenna circuit assembly, and
wherein the second rectifier circuit assembly is configured to rectify second electromagnetic energy harvested from the second antenna circuit assembly.

19. The device of claim 18, wherein the at least two antenna circuit assemblies form a first substrate of the device, wherein the at least two rectifier circuit assemblies form a second substrate of the device, and wherein the first substrate is stacked on the second substrate.

20. A method comprising:
providing an antenna circuit assembly;
directing, via a domed lens, one or more electromagnetic signals to one or more locations on an antenna circuit assembly in a radial pattern; and
rectifying, via a rectifier circuit assembly, electromagnetic energy harvested from the antenna circuit assembly into electrical power.
